(19) United States
(12) Patent Application Publication
(10) Pub. No.: US 2015/0030005 A1
(43) Pub. Date: Jan. 29, 2015

(54) Ack channel design for early termination of R99 downlink traffic

(71) Applicant: QUAL COMM Incorporated, San Diego, CA (US)

(72) Inventors: Sharad Deepak Sambhwani, San Diego, CA (US); Sony Akkarakaran, San Diego, CA (US)

(21) Appl. No.: 14/383,200

(22) PCT Filed: Mar. 4, 2013
(86) PCT No.: PCT/CN2013/072133

§ 371 Date: Sep. 5, 2014

Related U.S. Application Data
(63) Continuation-in-part of application No. PCT/CN2012/071938, filed on Mar. 5, 2012.
Application No. PCT/CN2012/071938 is a continuation-in-part of application No. PCT/CN2012/071883, filed on Feb. 26, 2012.

(51) Int. Cl. H04L 5/00; H04W 52/38; H04W 72/04

(52) U.S. Cl. CPC H04L 5/0055; H04W 72/0446; H04W 52/38
USPC 370/335

(57) ABSTRACT

A method, an apparatus, and a computer program product for wireless communication are provided. The apparatus receives a transmission and transmits an Ack regarding the transmission. A packet transmitting apparatus begins a transmission of a packet and receives an Ack regarding the transmission. The Ack may indicate early decoding of a packet comprised in the transmission. This enables the packet transmitting apparatus to cease transmission of the packet prior to transmission of the entire packet. The Ack may be transmitted using at least one of applying a pre-configured boost to the transmit power of at least a portion of a slot in which the Ack is transmitted, modulating a codeword pattern onto the symbols that would normally be transmitted in the slot, and transmitting the Ack on DPDCH.

### CLAIM OF PRIORITY UNDER 35 U.S.C. §120

The present application for patent claims priority to International Application No. PCT/CN2012/071938 entitled “Ack Channel Design For Early Termination of R99 Downlink Traffic” filed Mar. 5, 2012, and claims priority to International Application No. PCT/CN2013/071883 entitled “Method and system for early termination of transmissions in response to ack of early decoding” filed Feb. 26, 2013, both of which are assigned to the assignee hereof and hereby expressly incorporated by reference herein.

### REFERENCE TO CO-PENDING APPLICATIONS FOR PATENT

The present application for patent is related to co-pending U.S. patent applications:
“Method and System to Improve Frame Early Termination Success Rate” having Attorney Docket No. 121586, filed Feb. 21, 2013, which claims priority to U.S. Provisional Application No. 61/603,096 entitled “METHOD TO IMPROVE FRAME EARLY TERMINATION SUCCESS RATE OF CIRCUIT SWITCHED VOICE SENT ON R99DCH” filed Feb. 24, 2012, assigned to the assignee hereof, and expressly incorporated by reference herein; and
“Ack Channel Design for Early Termination of R99 Uplink Traffic” having Attorney Docket No. 121588, filed on Feb. 21, 2013, which claims priority to U.S. Provisional Application No. 61/603,109 entitled “Ack Channel Design For Early Termination of R99 Uplink Traffic” filed Feb. 24, 2012, assigned to the assignee hereof, and expressly incorporated by reference herein.

The present application for patent is related to:
International Patent Application No. PCT/CN2012/071676 titled “Ack Channel Design for Early Termination of R99 Downlink Traffic” having Attorney Docket No. 121604, filed on Feb. 27, 2012, assigned to the assignee hereof, and expressly incorporated by reference herein; AND
International Patent Application No. PCT/CN2012/071665 titled “Frame Early Termination of UL Transmissions on Dedicated Channel,” filed on Feb. 27, 2012, assigned to the assignee hereof, and expressly incorporated by reference herein.

### BACKGROUND

1. Field

The present disclosure relates generally to communication systems, and more particularly, to a method, a computer program product, and an apparatus that include an acknowledgement of early decoding of a packet transmission.

2. Background

Wireless communication networks are widely deployed to provide various communication services such as telephony, video, data, messaging, broadcasts, and so on. Such networks, which are usually multiple access networks, support communications for multiple users by sharing the available network resources. One example of such a network is the UMTS Terrestrial Radio Access Network (UTRAN). The UTRAN is the radio access network (RAN) defined as a part of the Universal Mobile Telecommunications System (UMTS), a third generation (3G) mobile phone technology supported by the 3rd Generation Partnership Project (3GPP). The UMTS, which is the successor to Global System for Mobile Communications (GSM) technologies, currently supports various air interface standards, such as Wideband-Code Division Multiple Access (W-CDMA), Time Division-Code Division Multiple Access (TD-CDMA), and Time Division-Synchronous Code Division Multiple Access (TD-SCDMA). The UMTS also supports enhanced 3G data communications protocols, such as High Speed Packet Access (HSPA), which provides higher data transfer speeds and capacity to associated UMTS networks.

As the demand for mobile broadband access continues to increase, research and development continue to advance the UMTS technologies not only to meet the growing demand for mobile broadband access, but to advance and enhance the user experience with mobile communications.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

Substantial system capacity gains and receiver power consumption reductions can be made possible through the use of early decoding. For example, system capacity gains can be possible when a transmitter is able to stop a packet transmission as soon as it is made aware that the receiver has succeeded in decoding the packet early. Receiver power consumption savings can also be possible because appropriate receiver subsystems can be powered down from the time of successful early decoding until the end of the packet duration.

In order to realize these capacity gains, the transmitter needs to a way to receive an indication from the receiver notifying it that the packet has been decoded prior to transmission of the entire packet. Thus, a fast and reliable feedback channel on which the receiver can inform the transmitter of the success or failure of its early decoding attempts is needed. Aspects presented herein provide the ability for a receiver to send such notification to the transmitter.

In an aspect of the disclosure, a method, a computer program product, and an apparatus are provided. The apparatus receives a transmission and transmits an Acknowledgement (Ack) regarding the transmission. The Ack can be transmitted using at least one of applying a pre-configured boost to the transmit power of at least a portion of a slot in which the Ack is transmitted, modulating a codeword pattern onto the symbols that would normally be transmitted in the slot, and transmitting the Ack on a dedicated physical data channel (DPDCH).

The apparatus can further early decode a packet comprised in the transmission. The Ack can indicate that the packet has been early decoded.

In another aspect of the disclosure, a method, a computer program product, and an apparatus are provided. The apparatus transmits wireless communication, e.g., to a receiving device. The apparatus receives an Ack regarding the transmission. The Ack can be received as a transmission using at least one of a pre-configured boost applied to the transmit power of at least a portion of a slot in which the Ack is transmitted, a modulation of a codeword pattern onto the symbols that would normally be transmitted in the slot, and a transmission on DPDCH.

The Ack may comprise an indication of early decoding of a packet comprised in the transmission. Thereafter, the apparatus can cease transmission of the packet in response to receiving the Ack.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which:

FIG. 1 is a diagram illustrating an example of a hardware implementation for an apparatus employing a processing system.

FIG. 2 is a block diagram conceptually illustrating an example of a telecommunications system.

FIG. 3 is a conceptual diagram illustrating an example of an access network.

FIG. 4 is a block diagram conceptually illustrating an example of a Node B in communication with a UE in a telecommunications system.

FIG. 5 illustrates aspects of an Ack transmission on the uplink.

FIG. 6 is a flow chart of a method of wireless communication.

FIG. 7 is a flow chart of a method of wireless communication.

FIG. 8 is a conceptual data flow diagram illustrating the data flow between different modules/means/components in an exemplary apparatus.

FIG. 9 is a conceptual data flow diagram illustrating the data flow between different modules/means/components in an exemplary apparatus.

FIG. 10 is a diagram illustrating an example of a hardware implementation for an apparatus employing a processing system

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

As used in this application, the terms “component,” “module,” “system” and the like are intended to include a computer-related entity, such as but not limited to hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets, such as data from one component interacting with another component in a local system, distributed system, and/or across a network such as the Internet with other systems by way of the signal.

Furthermore, various aspects are described herein in connection with a terminal, which can be a wired terminal or a wireless terminal. A terminal can also be called a system, device, subscriber unit, subscriber station, mobile station, mobile, mobile device, remote station, remote terminal, access terminal, user terminal, terminal, communication device, user agent, user device, or user equipment (UE). A wireless terminal may be a cellular telephone, a satellite phone, a cordless telephone, a Session Initiation Protocol (SIP) phone, a wireless local loop (WLL) station, a personal digital assistant (PDA), a handheld device having wireless connection capability, a computing device, or other processing devices connected to a wireless modem. Moreover, various aspects are described herein in connection with a base station. A base station may be utilized for communicating with wireless terminal(s) and may also be referred to as an access point, a Node B, or some other terminology.

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

The techniques described herein may be used for various wireless communication systems such as CDMA, TDMA, FDMA, OFDMA, SC-FDMA and other systems. The terms “system” and “network” are often used interchangeably. A CDMA system may implement a radio technology such as Universal Terrestrial Radio Access (UTRA), cdma2000, etc. UTRA includes Wideband-CDMA (W-CDMA) and other variants of CDMA. Further, cdma2000 covers IS-2000, IS-95 and IS-856 standards. A TDMA system may implement a radio technology such as Global System for Mobile Communications (GSM). An OFDMA system may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDM, etc. UTRA and E-UTRA are part of Universal Mobile Telecommunication System (UMTS). 3GPP Long Term Evolution (LTE) is a release of UMTS that uses E-UTRA, which employs OFDMA on the DL and SC-FDMA on the UL. UTRA, E-UTRA, UMTS, LTE and GSM are described in documents from an organization named “3rd Generation Partnership Project” (3GPP). Additionally, cdma2000 and UMB are described in documents from an organization named “3rd Generation Partnership Project 2” (3GPP2). Further, such wireless communication systems may additionally include peer-to-peer (e.g., mobile-to-mobile) ad hoc network systems often using unpaired unlicensed spectrums, 802.xx wireless LAN, BLUETOOTH and any other short- or long-range, wireless communication techniques.

Various aspects or features will be presented in terms of systems that may include a number of devices, components, modules, and the like. It is to be understood and appreciated that the various systems may include additional devices, components, modules, etc. and/or may not include all of the devices, components, modules etc. discussed in connection with the figures. A combination of these approaches may also be used.

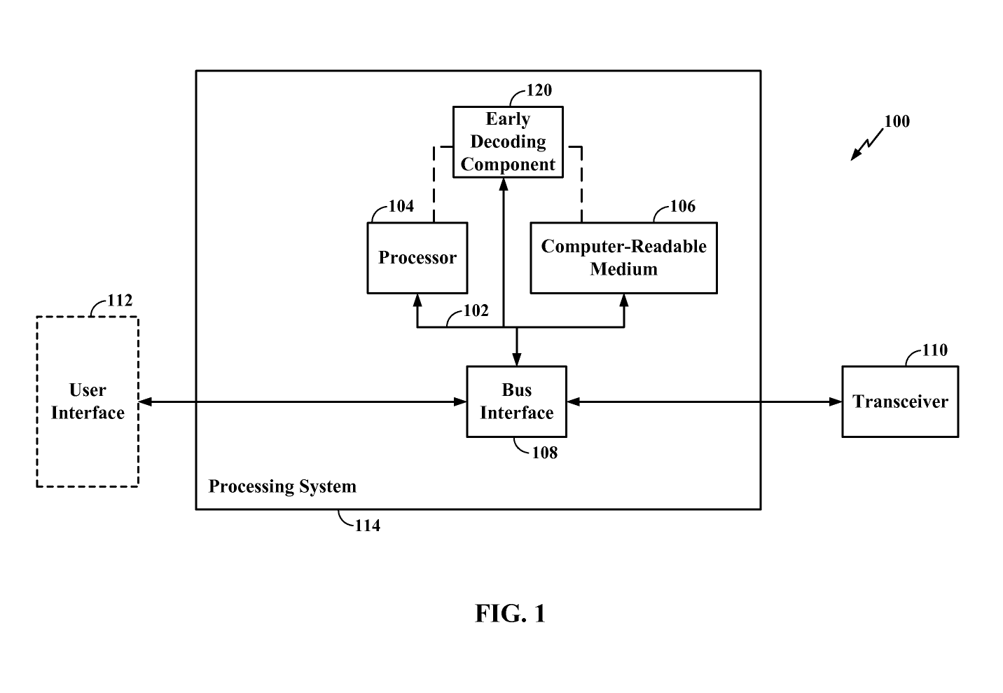

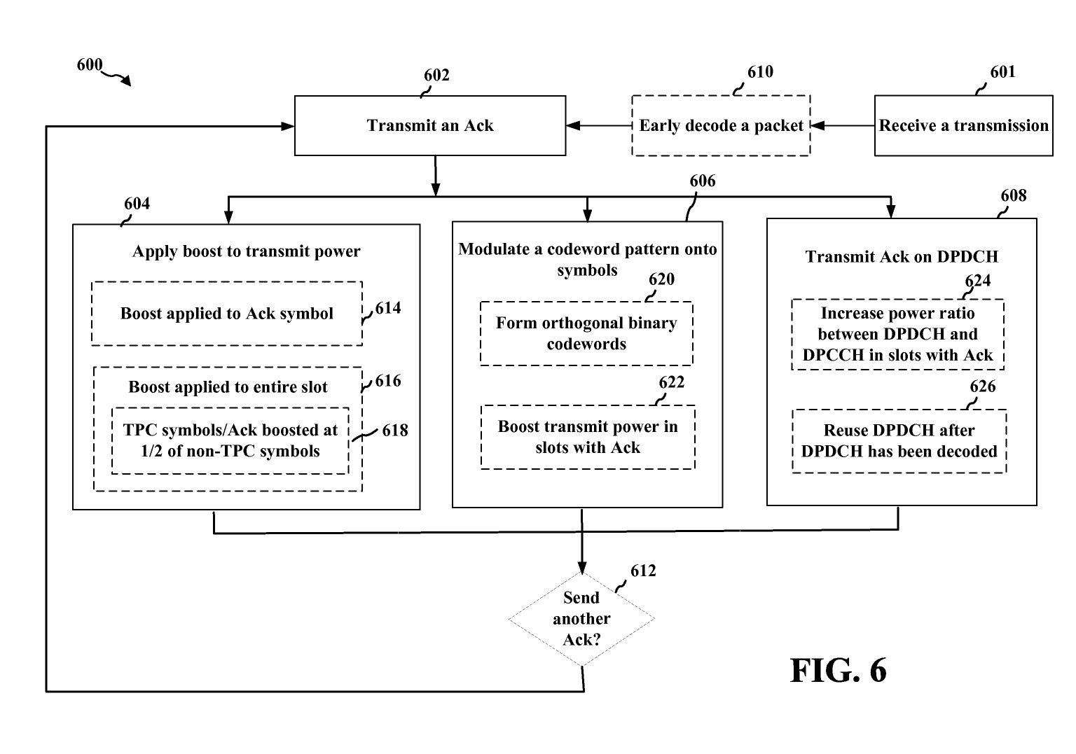

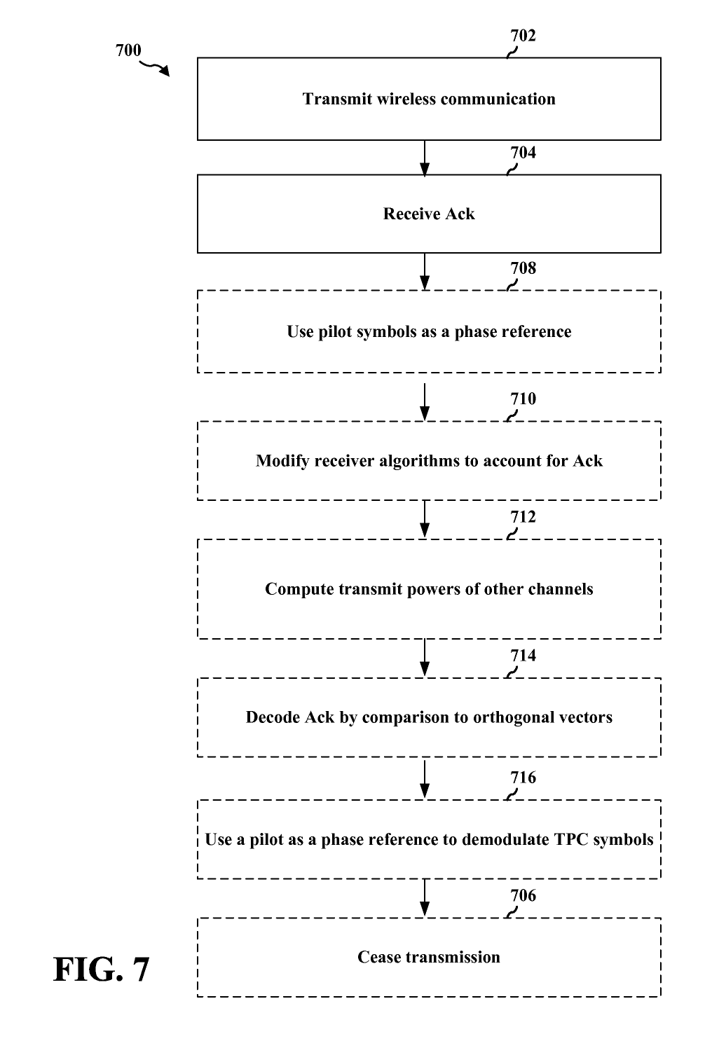

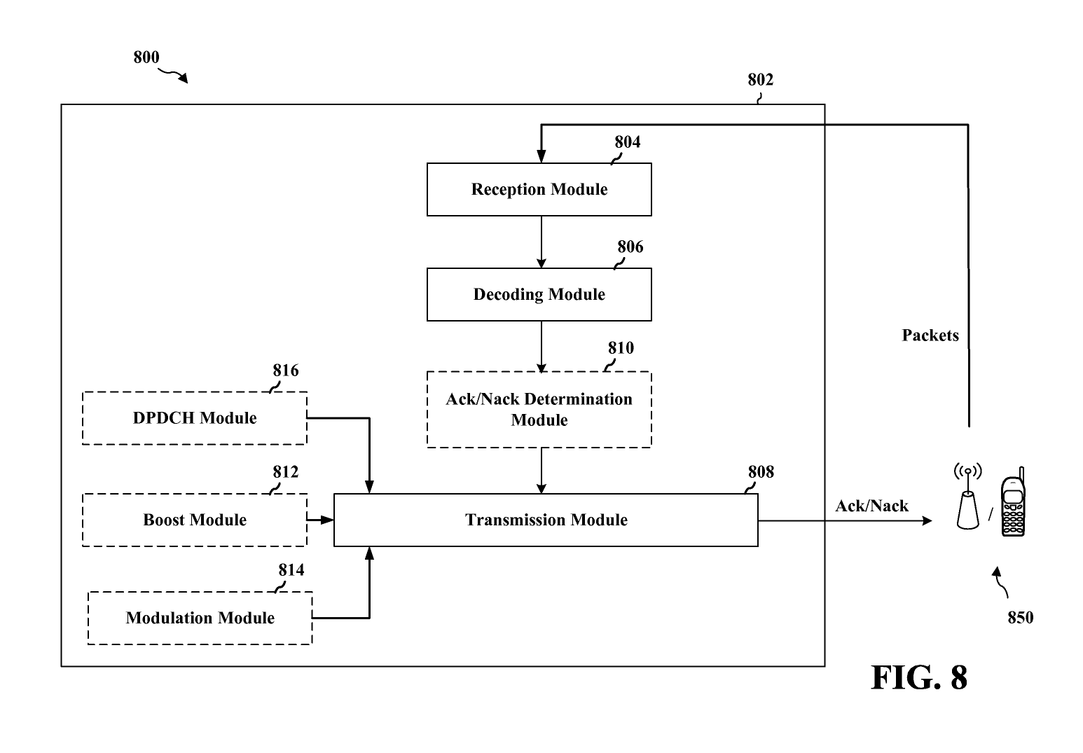

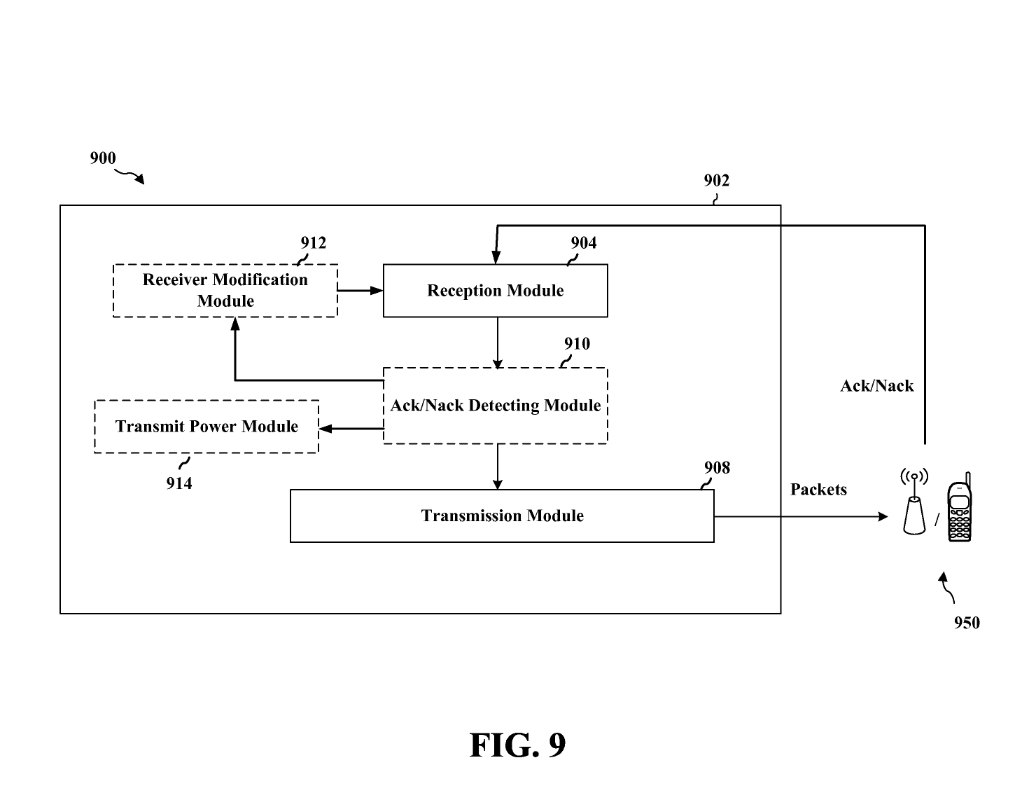

FIG. 1 is a conceptual diagram illustrating an example of a hardware implementation for an apparatus 100 employing a processing system 114. The processing system may further include an early decoding component 120 that is configured to transmit and receive Acks of early decoding. For example, the early decoding component 120 may include Ack transmission functions similar to those described in connection with FIGS. 6 and 8 and/or Ack reception functions similar to those described in connection with FIGS. 7 and 9. In some aspects, early decoding component 120 may be a stand-alone component within processing system 114, or may be defined by one or more processing modules within processor 104, or by executable code or instructions stored as computer-readable medium 106 and executable by processor 104, or some combination thereof.

For example, aspects of the Ack transmission function of the early decoding component 120 may transmit an Ack, e.g., of early decoding, using at least one of applying a pre-configured boost to the transmit power of at least a portion of a slot in which the Ack is transmitted, modulating a codeword pattern onto the symbols that would normally be transmitted in the slot, and transmitting the Ack on a DPDCH.

Aspects of the Ack reception function of the early decoding component 120 may receive an Ack, e.g., of early decoding, after beginning a transmission of a packet. The Ack can be received as a transmission using at least one of a pre-configured boost applied to the transmit power of at least a portion of a slot in which the Ack is transmitted, a modulation of a codeword pattern onto the symbols that would normally be transmitted in the slot, and a transmission on DPDCH.

In this example, the processing system 114 may be implemented with a bus architecture, represented generally by the bus 102. The bus 102 may include any number of interconnecting buses and bridges depending on the specific application of the processing system 114 and the overall design constraints. The bus 102 links together various circuits including one or more processors, represented generally by the processor 104, computer-readable media, represented generally by the computer-readable medium 106, and, in some aspects, early decoding component 120. The bus 102 may also link various other circuits such as timing sources, peripherals, voltage regulators, and power management circuits, which are well known in the art, and therefore, will not be described any further. A bus interface 108 provides an interface between the bus 102 and a transceiver 110. The transceiver 110 provides a means for communicating with various other apparatus over a transmission medium. Depending upon the nature of the apparatus, a user interface 112 (e.g., keypad, display, speaker, microphone, joystick) may also be provided.

The processor 104 is responsible for managing the bus 102 and general processing, including the execution of software stored on the computer-readable medium 106. The software, when executed by the processor 104, causes the processing system 114 to perform the various functions described infra for any particular apparatus. The computer-readable medium 106 may also be used for storing data that is manipulated by the processor 104 when executing software.

The various concepts presented throughout this disclosure may be implemented across a broad variety of telecommunication systems, network architectures, and communication standards.

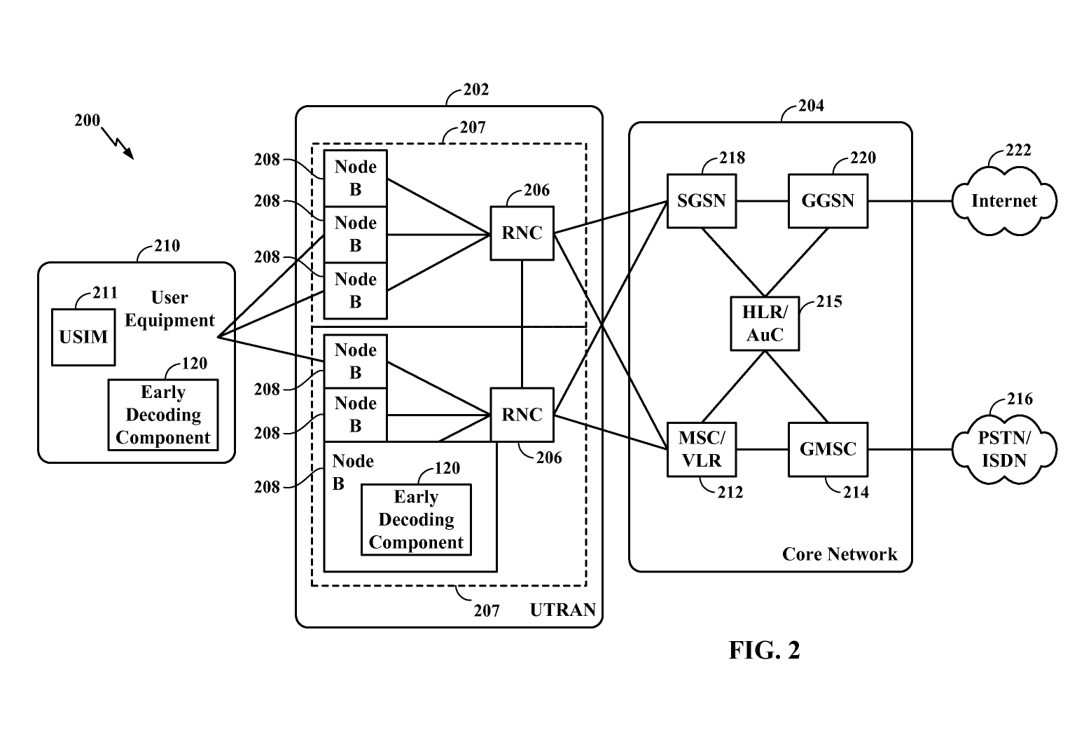

Referring to FIG. 2, by way of example and without limitation, the aspects of early decoding component 120 disclosed herein may be implemented by a User Equipment (UE) 210 and/or a Node B 208 operating in a UMTS system 200 employing a W-CDMA air interface. A UMTS network includes three interacting domains: a Core Network (CN) 204, a UMTS Terrestrial Radio Access Network (UTRAN) 202, and UE 210. In this example, the UTRAN 202 provides various wireless services including telephony, video, data, messaging, broadcasts, and/or other services. The UTRAN 202 may include a plurality of Radio Network Subsystems (RNSs) such as an RNS 207, each controlled by a respective Radio Network Controller (RNC) such as an RNC 206. Here, the UTRAN 202 may include any number of RNCs 206 and RNSs 207 in addition to the RNCs 206 and RNSs 207 illustrated herein. The RNC 206 is an apparatus responsible for, among other things, assigning, reconfiguring and releasing radio resources within the RNS 207. The RNC 206 may be interconnected to other RNCs (not shown) in the UTRAN 202 through various types of interfaces such as a direct physical connection, a virtual network, or the like, using any suitable transport network.

Communication between a UE 210, e.g., which may be UE 1130 in FIG. 1, and a Node B 208 may be considered as including a physical (PHY) layer and a medium access control (MAC) layer. Further, communication between a UE 210 and an RNC 206 by way of a respective Node B 208 may be considered as including a radio resource control (RRC) layer. In the instant specification, the PHY layer may be considered layer 1; the MAC layer may be considered layer 2; and the RRC layer may be considered layer 3. Information hereinbelow utilizes terminology introduced in Radio Resource Control (RRC) Protocol Specification, 3GPP TS 25.331 v9.1.0, incorporated herein by reference. As noted above, the UE 210 may include an early decoding component 120, as described in connection with FIG. 1.

The geographic region covered by the SRNS 207 may be divided into a number of cells, with a radio transceiver apparatus serving each cell. A radio transceiver apparatus is commonly referred to as a Node B in UMTS applications, but may also be referred to by those skilled in the art as a base station (BS), a base transceiver station (BTS), a radio base station, a radio transceiver, a transceiver function, a basic service set (BSS), an extended service set (ESS), an access point (AP), or some other suitable terminology. For clarity, three Node Bs 208 are shown in each SRNS 207; however, the SRNSs 207 may include any number of wireless Node Bs. The Node Bs 208 provide wireless access points to a core network (CN) 204 for any number of UEs. Although only one Node B 208 is illustrated as having early decoding component 120, as described in connection with FIG. 1, each of the Node Bs 208 may include such a component. Examples of a mobile apparatus include a cellular phone, a smart phone, a session initiation protocol (SIP) phone, a laptop, a notebook, a netbook, a smartbook, a personal digital assistant (PDA), a satellite radio, a global positioning system (GPS) device, a multimedia device, a video device, a digital audio player (e.g., MP3 player), a camera, a game console, or any other similar functioning device. The mobile apparatus is commonly referred to as user equipment (UE) in UMTS applications, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. In a UMTS system, the UE 210 may further include a universal subscriber identity module (USIM) 211, which contains a user's subscription information to a network. For illustrative purposes, one UE 210 is shown in communication with a number of the Node Bs 208. The DL, also called the forward link, refers to the communication link from a Node B 208 to a UE 210, and the UL, also called the reverse link, refers to the communication link from a UE 210 to a Node B 208.

The core network 204 interfaces with one or more access networks, such as the UTRAN 202. As shown, the core network 204 is a GSM core network. However, as those skilled in the art will recognize, the various concepts presented throughout this disclosure may be implemented in a RAN, or other suitable access network, to provide UEs with access to types of core networks other than GSM networks.

The core network 204 includes a circuit-switched (CS) domain and a packet-switched (PS) domain. Some of the circuit-switched elements are a Mobile services Switching Centre (MSC), a Visitor location register (VLR) and a Gateway MSC. Packet-switched elements include a Serving GPRS Support Node (SGSN) and a Gateway GPRS Support Node (GGSN). Some network elements, like EIR, HLR, VLR and AuC may be shared by both of the circuit-switched and packet-switched domains. In the illustrated example, the core network 204 supports circuit-switched services with a MSC 212 and a GMSC 214. In some applications, the GMSC 214 may be referred to as a media gateway (MGW). One or more RNCs, such as the RNC 206, may be connected to the MSC 212. The MSC 212 is an apparatus that controls call setup, call routing, and UE mobility functions. The MSC 212 also includes a visitor location register (VLR) that contains subscriber-related information for the duration that a UE is in the coverage area of the MSC 212. The GMSC 214 provides a gateway through the MSC 212 for the UE to access a circuit-switched network 216. The core network 204 includes a home location register (HLR) 215 containing subscriber data, such as the data reflecting the details of the services to which a particular user has subscribed. The HLR is also associated with an authentication center (AuC) that contains subscriber-specific authentication data. When a call is received for a particular UE, the GMSC 214 queries the HLR 215 to determine the UE's location and forwards the call to the particular MSC serving that location.

The core network 204 also supports packet-data services with a serving GPRS support node (SGSN) 218 and a gateway GPRS support node (GGSN) 220. GPRS, which stands for General Packet Radio Service, is designed to provide packet-data services at speeds higher than those available with standard circuit-switched data services. The GGSN 220 provides a connection for the UTRAN 202 to a packet-based network 222. The packet-based network 222 may be the Internet, a private data network, or some other suitable packet-based network. The primary function of the GGSN 220 is to provide the UEs 210 with packet-based network connectivity. Data packets may be transferred between the GGSN 220 and the UEs 210 through the SGSN 218, which performs primarily the same functions in the packet-based domain as the MSC 212 performs in the circuit-switched domain.

The UMTS air interface is a spread spectrum Direct-Sequence Code Division Multiple Access (DS-CDMA) system. The spread spectrum DS-CDMA spreads user data through multiplication by a sequence of pseudorandom bits called chips. The W-CDMA air interface for UMTS is based on such direct sequence spread spectrum technology and additionally calls for a frequency division duplexing (FDD). FDD uses a different carrier frequency for the UL and DL between a Node B 208 and a UE 210. Another air interface for UMTS that utilizes DS-CDMA, and uses time division duplexing, is the TD-SCDMA air interface. Those skilled in the art will recognize that although various examples described herein may refer to a WCDMA air interface, the underlying principles are equally applicable to a TD-SCDMA air interface.

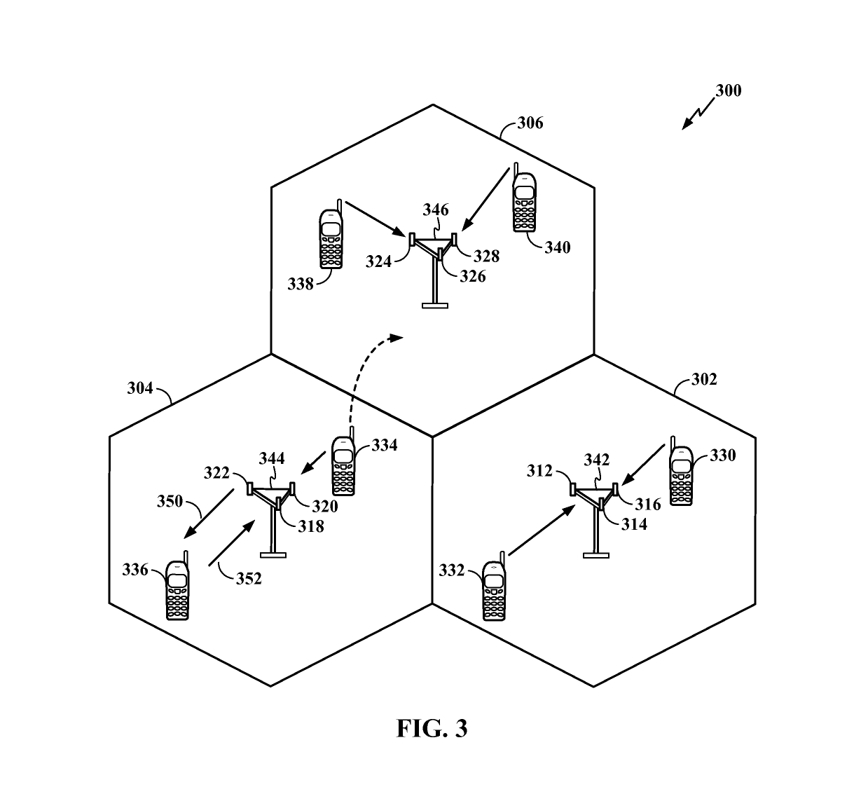

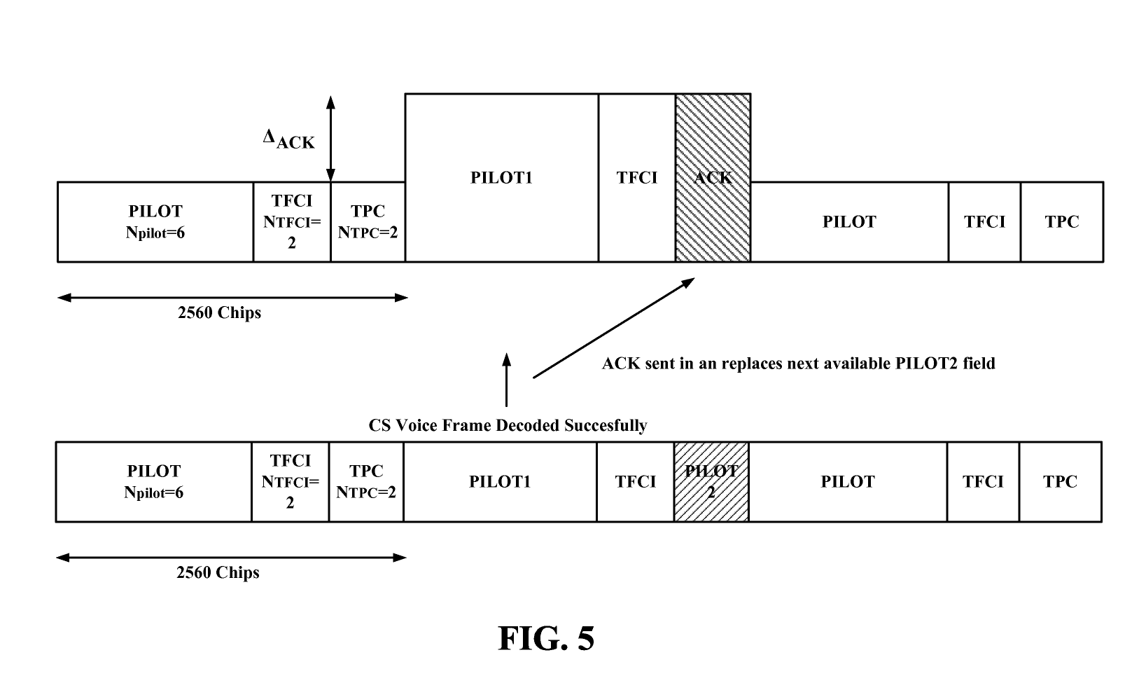

Referring to FIG. 3, an access network 300 in a UTRAN architecture is illustrated. The multiple access wireless communication system includes multiple cellular regions (cells), including cells 302, 304, and 306, each of which may include one or more sectors. Aspects of early decoding and Ack transmission, as described in connection with FIGS. 5-10, including early decoding component 120 of FIG. 1 may be employed in communication between UEs 330, 332, 334, 336, 338, and 340 and cells 302, 304, and 306. For example, a UE 336 may receive a packet transmission 350 from transmitter 344. The UE 336 may attempt to early decode the packet transmission 350 prior to receive the entire packet transmission 350. Once the UE 336 has successfully early decoded the packet transmission, the UE 336 may transmit an Ack 352 to the transmitter 344. This enables the transmitter to cease transmission of the packet transmission, thereby providing system capacity gains.

The multiple sectors can be formed by groups of antennas with each antenna responsible for communication with UEs in a portion of the cell. For example, in cell 302, antenna groups 312, 314, and 316 may each correspond to a different sector. In cell 304, antenna groups 318, 320, and 322 each correspond to a different sector. In cell 306, antenna groups 324, 326, and 328 each correspond to a different sector. The cells 302, 304 and 306 may include several wireless communication devices, e.g., User Equipment or UEs, which may be in communication with one or more sectors of each cell 302, 304 or 306. For example, UEs 330 and 332 may be in communication with Node B 342, UEs 334 and 336 may be in communication with Node B 344, and UEs 338 and 340 can be in communication with Node B 346. Here, each Node B 342, 344, 346 is configured to provide an access point to a core network 204 (see FIG. 2) for all the UEs 330, 332, 334, 336, 338, 340 in the respective cells 302, 304, and 306.

As the UE 334 moves from the illustrated location in cell 304 into cell 306, a serving cell change (SCC) or handover may occur in which communication with the UE 334 transitions from the cell 304, which may be referred to as the source cell, to cell 306, which may be referred to as the target cell. Management of the handover procedure may take place at the UE 334, at the Node Bs corresponding to the respective cells, at a radio network controller 206 (see FIG. 2), or at another suitable node in the wireless network. For example, during a call with the source cell 304, or at any other time, the UE 334 may monitor various parameters of the source cell 304 as well as various parameters of neighboring cells such as cells 306 and 302. Further, depending on the quality of these parameters, the UE 334 may maintain communication with one or more of the neighboring cells. During this time, the UE 334 may maintain an Active Set, that is, a list of cells that the UE 334 is simultaneously connected to (i.e., the UTRA cells that are currently assigning a DL dedicated physical channel DPCH or fractional DL dedicated physical channel F-DPCH to the UE 334 may constitute the Active Set).

The modulation and multiple access scheme employed by the access network 300 may vary depending on the particular telecommunications standard being deployed. By way of example, the standard may include Evolution-Data Optimized (EV-DO) or Ultra Mobile Broadband (UMB). EV-DO and UMB are air interface standards promulgated by the 3rd Generation Partnership Project 2 (3GPP2) as part of the CDMA2000 family of standards and employs CDMA to provide broadband Internet access to mobile stations. The standard may alternately be Universal Terrestrial Radio Access (UTRA) employing Wideband-CDMA (W-CDMA) and other variants of CDMA, such as TD-SCDMA; Global System for Mobile Communications (GSM) employing TDMA; and Evolved UTRA (E-UTRA), Ultra Mobile Broadband (UMB), IEEE 802.11 (Wi-Fi), IEEE 802.16 (WiMAX), IEEE 802.20, and Flash-OFDM employing OFDMA. UTRA, E-UTRA, UMTS, LTE, LTE Advanced, and GSM are described in documents from the 3GPP organization. CDMA2000 and UMB are described in documents from the 3GPP2 organization. The actual wireless communication standard and the multiple access technology employed will depend on the specific application and the overall design constraints imposed on the system.

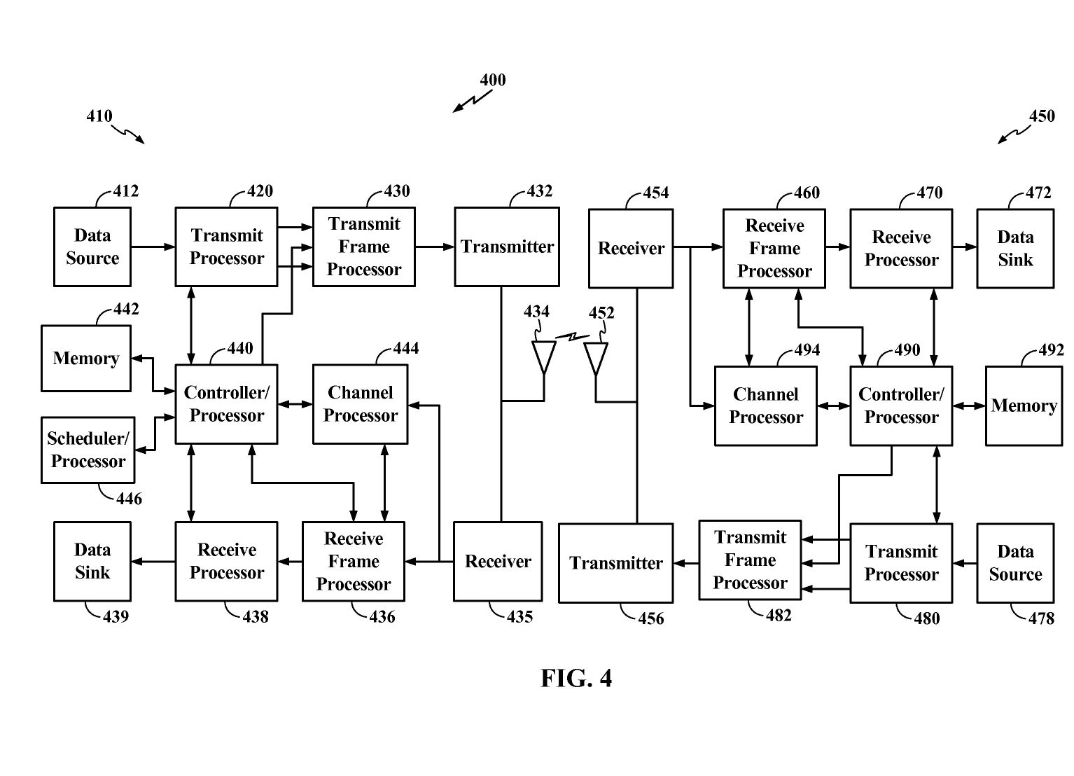

FIG. 4 is a block diagram of a Node B 410 in communication with a UE 450, where the Node B 410 may be the Node B 208 in FIG. 2, and the UE 450 may be the UE 210 in FIG. 2. As described herein, in Node B 410, the Ack transmission function of early decoding component 120 of FIGS. 1 and 2, may include any or the TX Processor 420, the TX Frame Processor, and the controller/processor 440. The Ack reception function of the early decoding component of Node B 410 may include any of the RX Processor 438, the RX Frame Processor, and the controller/processor 440. In UE 450, the Ack transmission function of the early decoding component 120 of FIGS. 1 and 2 may include any of the TX Processor 480, the Transmit Frame Processor 482, and Controller/processor 490. The Ack reception function of the early decoding component 120 in UE 450 may include any of the RX Processor 470, the RX Frame Processor 460, and the controller/processor 490.

In the DL communication, a transmit processor 420 may receive data from a data source 412 and control signals from a controller/processor 440. The transmit processor 420 provides various signal processing functions for the data and control signals, as well as reference signals (e.g., pilot signals). For example, the transmit processor 420 may provide cyclic redundancy check (CRC) codes for error detection, coding and interleaving to facilitate forward error correction (FEC), mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM), and the like), spreading with orthogonal variable spreading factors (OVSF), and multiplying with scrambling codes to produce a series of symbols. Channel estimates from a channel processor 444 may be used by a controller/processor 440 to determine the coding, modulation, spreading, and/or scrambling schemes for the transmit processor 420. These channel estimates may be derived from a reference signal transmitted by the UE 450 or from feedback from the UE 450. The symbols generated by the transmit processor 420 are provided to a transmit frame processor 430 to create a frame structure. The transmit frame processor 430 creates this frame structure by multiplexing the symbols with information from the controller/processor 440, resulting in a series of frames. The frames are then provided to a transmitter 432, which provides various signal conditioning functions including amplifying, filtering, and modulating the frames onto a carrier for DL transmission over the wireless medium through antenna 434. The antenna 434 may include one or more antennas, for example, including beam steering bidirectional adaptive antenna arrays or other similar beam technologies.

At the UE 450, a receiver 454 receives the DL transmission through an antenna 452 and processes the transmission to recover the information modulated onto the carrier. The information recovered by the receiver 454 is provided to a receive frame processor 460, which parses each frame, and provides information from the frames to a channel processor 494 and the data, control, and reference signals to a receive processor 470. The receive processor 470 then performs the inverse of the processing performed by the transmit processor 420 in the Node B 410. More specifically, the receive processor 470 descrambles and despreads the symbols, and then determines the most likely signal constellation points transmitted by the Node B 410 based on the modulation scheme. These soft decisions may be based on channel estimates computed by the channel processor 494. The soft decisions are then decoded and deinterleaved to recover the data, control, and reference signals. The CRC codes are then checked to determine whether the frames were successfully decoded. The data carried by the successfully decoded frames will then be provided to a data sink 472, which represents applications running in the UE 450 and/or various user interfaces (e.g., display). Control signals carried by successfully decoded frames will be provided to a controller/processor 490. When frames are unsuccessfully decoded by the receiver processor 470, the controller/processor 490 may also use an acknowledgement (ACK) and/or negative acknowledgement (NACK) protocol to support retransmission requests for those frames.

In the UL, data from a data source 478 and control signals from the controller/processor 490 are provided to a transmit processor 480. The data source 478 may represent applications running in the UE 450 and various user interfaces (e.g., keyboard). Similar to the functionality described in connection with the DL transmission by the Node B 410, the transmit processor 480 provides various signal processing functions including CRC codes, coding and interleaving to facilitate FEC, mapping to signal constellations, spreading with OVSFs, and scrambling to produce a series of symbols. Channel estimates, derived by the channel processor 494 from a reference signal transmitted by the Node B 410 or from feedback contained in the midamble transmitted by the Node B 410, may be used to select the appropriate coding, modulation, spreading, and/or scrambling schemes. The symbols produced by the transmit processor 480 will be provided to a transmit frame processor 482 to create a frame structure. The transmit frame processor 482 creates this frame structure by multiplexing the symbols with information from the controller/processor 490, resulting in a series of frames. The frames are then provided to a transmitter 456, which provides various signal conditioning functions including amplification, filtering, and modulating the frames onto a carrier for UL transmission over the wireless medium through the antenna 452.

The UL transmission is processed at the Node B 410 in a manner similar to that described in connection with the receiver function at the UE 450. A receiver 435 receives the UL transmission through the antenna 434 and processes the transmission to recover the information modulated onto the carrier. The information recovered by the receiver 435 is provided to a receive frame processor 436, which parses each frame, and provides information from the frames to the channel processor 444 and the data, control, and reference signals to a receive processor 438. The receive processor 438 performs the inverse of the processing performed by the transmit processor 480 in the UE 450. The data and control signals carried by the successfully decoded frames may then be provided to a data sink 439 and the controller/processor, respectively. If some of the frames were unsuccessfully decoded by the receive processor, the controller/processor 440 may also use an acknowledgement (ACK) and/or negative acknowledgement (NACK) protocol to support retransmission requests for those frames.

The controller/processors 440 and 490 may be used to direct the operation at the Node B 410 and the UE 450, respectively. For example, the controller/processors 440 and 490 may provide various functions including timing, peripheral interfaces, voltage regulation, power management, and other control functions. The computer readable media of memories 442 and 492 may store data and software for the Node B 410 and the UE 450, respectively. A scheduler/processor 446 at the Node B 410 may be used to allocate resources to the UEs and schedule DL and/or UL transmissions for the UEs.

Substantial system capacity gains and receiver power consumption reductions can be made possible through the use of early decoding. For example, system capacity gains can be possible when a transmitter is able to stop a packet transmission as soon as it is made aware that the receiver has succeeded in decoding the packet early. Receiver power consumption savings can also be possible because appropriate receiver subsystems can be powered down from the time of successful early decoding until the end of the packet duration.

In order to realize these capacity gains, the transmitter needs to a way to receive an indication from the receiver notifying it that the packet has been decoded prior to transmission of the entire packet. Thus, a fast and reliable feedback channel on which the receiver can inform the transmitter of the success or failure of its early decoding attempts is needed.

International Application No. PCT/CN2009/075179 (WO2011/063569) entitled “Increasing Capacity in Wireless Communications,” (hereinafter referred to as [1]) the entire contents of which are hereby incorporated by reference herein, outlined time division multiplexing (TDM) and code division multiplexing (CDM) approaches to design of an Ack channel. In U.S. Provisional Application No. 61/603,109 (Attorney Docket No. 121588P1) entitled “Ack channel design for early termination of R99 uplink traffic,” filed Feb. 24, 2012, (hereinafter referred to as [2]), which is hereby incorporated by reference herein, detailed design principles and options were presented, some specific to the Ack for uplink traffic, and many equally applicable to both uplink and downlink Ack channels. In International Application No. PCT/CN2012/071665 (Attorney Docket No. 121601P1) entitled “Frame Early Termination of UL transmissions on dedicated channel,” filed Feb. 27, 2012 in China, (hereinafter referred to as [3]) which is hereby incorporated by reference herein, some specific design options were considered for the Ack channel for downlink traffic, in the context of defining algorithms for early termination of transmissions in response to Acks.

Aspects presented herein provide additional implementation aspects and design options that provide solutions to issues that may arise using such approaches. R99 packets that are transmitted over time durations, e.g., transmission time intervals (TTIs), of 10 ms, 20 ms, 40 ms or 80 ms may be decodable by the receiver prior to reception of the entire packet. Once decoded, an Ack can be sent in order to notify the device transmitting the R99 packet to cease transmission, thereby provide a reduction in transmission power requirements and system capacity gains.

As described in [3], one design option for sending Ack/Nack on the uplink is to carry it on the uplink dedicated physical control channel (DPCCH), by replacing the transmit power control (TPC) field by an on/off keyed Ack/negative acknowledgement (Nack) field in a subset of slots, e.g., every alternate slot.

To be received reliably, the Ack may need a higher transmit power than the TPC. One option is to boost the Ack symbols by a pre-configured power offset relative to the TPC symbols. In some cases, selective boosting of certain symbols within the slot could lead to harmful RF impairments. To avoid this, the entire DPCCH slot in which an Ack has to be sent can be boosted in power relative to the power level at which it would have been transmitted as per the current R99 specification. This power boost only applies for the slots in which ‘Pick’ has to be sent, and not for slots where ‘Nack’ is sent or for slots that are not reserved for Ack/Nack transmission. The receiver algorithms that rely on DPCCH symbol power measurements can be appropriately modified to account for this known power boost once the Ack/Nack detector detects an Ack in a particular slot.

Replacing TPC by an Ack in selected uplink slots has the impact of reducing the power-control rate for the downlink. Similar to the case explained in [2], negative performance impacts from this can be mitigated by optimizing the configuration parameters such as power-control stepsize and receiver algorithm parameters such as SNR estimation filter coefficients, to account for the reduced power-control rate. Also as in [2], this impact could be reduced by an alternative design that replaces only a part of the TPC symbols by Ack/Nack symbols in the slots reserved for sending Ack/Nack; for example, in-phase-quadrature-phase (I-Q) multiplexing of TPC and Ack/Nack symbols.

Another approach for the Ack channel design is a CDM approach, in which the Ack/Nack is sent on a different channel that uses a separate spreading code. This has the advantage of keeping the uplink power-control rate undisturbed, at the expense of using an additional code resource. However, the new code resource need not be exclusively for the Ack/Nack channel, other already existing control channels may be modified to accommodate the Ack/Nack channel. For example, the encoding of the enhanced DPCCH (E-DPCCH) or the high speed DPCCH (HS-DPCCH) could be modified to allow inclusion of a bit indicating Ack/Nack.

The above discussed methods and systems may reside in the UE receiver and/or Node B transmitter. Further, the implementation of the presently discussed embodiments may involve a standards change.

An Ack can be sent by replacing the TPC field of certain pre-defined slots (e.g., every alternate slot) by an on-off keyed Ack/Nack field. Through the use of such on-off keying, “off” transmissions that are sent with zero power represent a Nack until an “on” transmission is sent at a pre-configured power to represent a positive Ack. Thus, only the Nack symbol would be sent with zero power, and all the symbols within the slow would not have the same transmit power. This could lead to a degradation of the waveform cubic metric, necessitating a transmit power back-off. Aspects presented herein avoid this problem and provide a way to transmit an Ack while preserving the property that all symbols within a slot have the same transmit power.

One way to avoid the above-mentioned problem with on-off keying is to indicate a Nack using a dummy symbol rather than using zero power, e.g., discontinuous transmission (DTX). An Ack can be indicated using the same symbol, but sent at a higher power level. In both cases, the same power level can be used for all symbols in the slot. Although the slot carrying the Ack would have a different power level than that carrying the Nack, the discontinuity in power occurs only once per slot, as opposed to once per symbol if on-off keying of only the Ack/Nack field is used. A receiver may find it difficult to distinguish an Ack from a Nack solely by using the transmit power levels, due to channel fading, power control, etc. Therefore, different symbols may also be used in order to indicate an Ack and a Nack. For example, the Nack could be a symbol value of −1 sent at low power, while the Ack could be the symbol value of +1 sent at higher power. The higher power may comprise an increase of Δ_{Ack}, as illustrated in FIG. 5. This increases the separation between the two possible symbol hypotheses so that the receiver can more accurately decode between Acks and Nacks. Asymmetric performance requirements on Nack-to-Ack vs. Ack-to-Nack error probabilities can be achieved by appropriate choice of the decision threshold, just as in the case of on-off keying. However, such a decision can be based on coherent detection rather than pure energy level measurement, and hence it does need a channel estimate to serve as phase reference. The pilot symbols transmitted in the same slot on the DPCCH can serve as such a phase reference. Once the TFCI has been decoded, it can also be used as a pilot, for example, for demodulation of the DPDCH. That use can also be extended to assist in demodulation of the Ack/Nack field.

Another approach to Ack/Nack signalling is to continue to use on-off keying, but to I-Q multiplex the Ack/Nack with the TPC field, similar to that suggested in [2]. In this aspect, TPC can be sent every slot, preserving the current 1500 Hz downlink power-control rate, exactly as per the current specification, in the slots where Nack is signalled. In order to signal an Ack, all the non-TPC symbols in the slot can be boosted in power. The TPC symbols can be boosted to half the power of the non-TPC symbols, and the remaining half of the power on the TPC symbols can be used to transmit Ack symbols I-Q multiplexed with the TPC symbols. The power on each branch, i.e. I and Q, does vary faster than once per slot (at the Ack symbol). However the total power on both I and Q branches varies only once per slot. Therefore, this could potentially reduce an impact to the cubic metric.

The approaches discussed supra attempt to preserve the existing slot structure as much as possible, modifying only the slot power level for slots where an Ack is to be sent and the Ack symbol itself, in the slots reserved for Ack/Nack signalling. The intent is to keep undisturbed as far as possible the current processing of the other symbols in the slot, e.g., the pilot and transport format combination indicator (TFCI). Other aspects may include some modifications to this processing. For example, when the uplink DPDCH packet has not yet been decoded, and the pilots are being used to demodulate DPDCH, transmitting an Ack in a slot causes the pilots in that slot to be received at higher power than usual. The receiver's channel estimation algorithm needs to take this into account, using input from an Ack/Nack decision module, and the channel estimation may degrade if the Ack/Nack detector does not perform sufficiently well. Given that receiver algorithm changes will be unavoidable, additional aspects may modify the full slot structure, necessitating more complex receiver schemes but with better performance.

For example, the Ack/Nack information can be encoded using two orthogonal binary codewords that modulate the pilot symbols within each slot. For example, if p1, p2, p3, p4, p5, p6 are the six pilot symbols that would be normally sent in a particular slot, a Nack can be indicated by sending these six symbols. However, the symbols p1, p2, p3, −p4, −p5 and −p6 can be sent to indicate an Ack. The receiver can distinguish Ack from Nack by comparing the energies of the correlations between the vector of received pilots r1, r2, r3, r4, r5, r6 and the two orthogonal vectors [1 1 1 1 1 1] and [1 1 1 −1 −1 −1].

Distributing the information over multiple pilot symbols can reduce the extra power requirement to transmit the Ack. Also, this avoids having to reserve slots in which the TPC field is replaced by an Ack field, and thus TPC can be sent every slot, preserving the current 1500 Hz downlink power control rate.

In an additional aspect, once the transmitter is aware that the receiver has decoded the TFCI field, e.g., by receiving Ack on the downlink, it can extend the orthogonal code overlay of the Ack/Nack information to include both the pilot and the TFCI symbols.

In another variation, the modulation by the orthogonal vectors, e.g., one consisting of all ones, and the other of an equal number of +1 and −1, could be applied only on the TPC field instead of on the pilots, or on the pilots and TFCI. In this case the pilots can be used as phase reference to demodulate the resulting TPC/Ack-Nack field. For example, if the TPC field has two bits, the current specification requires transmission of 00 or 11 in order to indicate an up or down command. The unused values 10 and 01 can be used to multiplex the Ack information along with the TPC. For example, the value 10 could represent Ack and TPC up command, while 01 could represent Ack and TPC down command, while the values 00 and 11 retain their meanings as per the current specification and signify Nack in addition to those meanings.

As already mentioned, all the approaches described supra require the receiver to modify its DPCCH pilot processing depending on whether Ack has been detected in the slot; e.g., in order to account for any additional transmit power boost that has been applied in the slot. A CDM approach outlined in, where the Ack channel is sent on a separate spreading code, avoids this requirement. When using a CDM approach, the receiver must then monitor receptions on this spreading code instead. However, the use of a new spreading code could have some impact to the cubic metric, and re-using codes for existing control channels (E-DPCCH or HS-DPCCH) will require modifying their encoding to include the Ack/Nack information.

Therefore, aspect may include re-using the uplink DPDCH for this purpose. If the DPDCH has already been decoded and acknowledged, the transmitter would have turned off DPDCH transmissions. Hence the DPDCH can then be re-used to send Ack. An Ack can be indicated by transmitting a pre-determined pattern of modulation symbols. Alternately, an Ack can be indicated by transmitting the same symbols that would have been transmitted if the DPDCH had not already been decoded. As another option, an Ack can be indicated by transmitting some function of these symbols that would have been transmitted, e.g., the negative of these symbols. The transmission can be made at a pre-determined power offset (T2P) with respect to DPCCH, and need not be the same as the usual DPDCH T2P used for other slots where Ack is not sent.

Even if the uplink DPDCH transmission has not yet been decoded, an Ack may be signalled in a slot by increasing the DPDCH T2P for that slot. This increase may be harder to detect when compared to the situation when the DPDCH has already decoded, where the detector was faced with merely detecting presence or absence of the DPDCH. Such difficulty in detection can be compensated for by using a sufficiently large T2P increase. The value of the T2P increase used could also be a function of other parameters such as the spreading factor, which may affect the performance of the receiver subsystem that detects this T2P increase. The detection can possibly be further aided by repeating an Ack over multiple slots, or until the UE detects that it has been received. A determination may be made regarding whether the Ack has been received by monitoring receiver power of the downlink data packet even after it has been decoded in order to determine that whether its transmission has ceased in response to the Ack.

In another approach, the transmission of the Ack can be delayed until the uplink DPDCH has been decoded, in order to increase its reliability. This increase in reliability may be at the expense of some of the downlink early termination gain.

Finally, it should be noted that although the above scheme of reusing DPDCH for Ack has been described in the context of Ack transmission on uplink to acknowledge downlink packet transmissions, it is equally applicable to Ack transmission on the downlink to acknowledge uplink packets. Some of the schemes described in [2] for this purpose may requiring sending very high power concentrated in a single Ack symbol, which may cause issues with RF implementations. If the downlink DPDCH has already been decoded, the Ack power can instead be spread out over several DPDCH symbols, reducing the harmful RF effects. Also, this enables sending an Ack in any slot, reducing Ack delay compared to some schemes in [2] in which an Ack can only be sent in a certain reserved subset of slots.

In any of these aspects, a decision could also be made whether to avoid sending an Ack even though the packet was decoded, based on other criteria. For example, the receiver may determine not to send an Ack even though it has early decoded the packet transmission when the transmitter that would send the Ack is close to its maximum power limit. The receiver may also determine not to send an Ack, even though it has early decoded the packet transmission, when the packet is only decoded very near to its completion. For example, the UE may make this determination when the amount of time for which the packet transmission could be stopped, after accounting for the delay in receiving the Ack, would be very small or zero.

The above discussed methods may be implemented for example in the UE receiver and/or Node B transmitter as appropriate. Further, the present invention may involve a standards change.

FIG. 6 is a flow chart of a method 600 of wireless communication. The method may be performed by a wireless device that receives wireless communication, such as a UE or Node B. In an aspect, the device may be an apparatus 802 as described in connection with FIG. 8. At 601, the device receives a transmission, e.g., a packet transmission. The device may receive the wireless communication from a packet transmitting device such as a Node B or UE, e.g., 850 in FIG. 8 or 902 in FIG. 9. The reception may be performed by a reception module, e.g., 804 in FIG. 8. At 602, the device transmits an acknowledgement regarding the transmission received at 601. In an aspect, the acknowledgement may be transmitted via a transmission module, e.g., 808 illustrated in FIG. 8. The Ack may be transmitted, e.g., using any of applying a pre-configured boost to the transmit power of at least a portion of a slot in which the Ack is transmitted as at 604, modulating a codeword pattern onto the symbols that would normally be transmitted in the slot as at 606, and transmitting the Ack on DPDCH as at 608.

The Ack may be transmitted on either an UL or on a DL. The Ack, e.g., may be transmitted on certain slots of an R99 uplink channel for traffic packets sent on an R99 downlink channel. Such an R99 uplink channel may comprise a DPCCH channel.

The device may optionally, at 610, early decode a packet comprised in the transmission prior to receiving the entire packet, and the Ack may indicate that the packet has been early decoded. Optional aspects are illustrated having a dashed line. In an aspect, the decoding may be performed by a decoding module, e.g., 806 illustrated in FIG. 8.

An Ack might be sent only once per packet decoding. Alternately, the Ack may be sent multiple times per successful decoding of the packet. This may increase the reliability of reception of the Ack. In another aspect, the Ack may be repeated only in certain circumstances. Thus, the device may determine at 612 whether to send an additional Ack. This determination may be based, e.g., on whether transmission of the packet has ceased. Such a determination may be made by continuing to monitor an energy of the received packet after it has been decoded in order to determine whether the packet transmitter has stopped the packet transmission in response to the previous Ack. In an aspect, the determination regarding whether to send an additional Ack may be performed by an Ack/Nack determination module, e.g., 810 as illustrated in connection with FIG. 8.

At 604, the Ack is transmitted by applying a pre-configured boost to the transmit power of at least a portion of a slot in which the Ack is transmitted, e.g., as illustrated in FIG. 5. In an aspect, the pre-configured boost may be performed by a boost module, e.g., 812 as illustrated in connection with FIG. 8.

When the Ack is transmitted by applying a pre-configured boost to the transmit power of at least a portion of a slot in which the Ack is transmitted at 604, the pre-configured boost may be applied to the transmit power of the Ack symbol in the slot at 614, e.g., only to the Ack symbol.

The pre-configured boost at 604 may be applied to the transmit power of the entire slot in which the Ack is transmitted at 616.

When the pre-configured boost is applied to the entire slot at 616, a pre-defined boost P may applied to the transmit power of all non-TPC symbols in the slot, and a boost of P/2 may applied to the TPC symbols and the Ack at 618. The Ack may further be I-Q multiplexed with the TPC symbols. This enables the use of on-off keying. However, through the use of I-Q multiplexing, the TPC can be sent every slot, e.g., preserving the current 1500 Hz downlink power control rate in slots where a Nack is indicated. When an Ack is transmitted, the power on each branch, e.g., I and Q, does vary faster than once per slot, e.g., at the Ack symbol. However, the total power on both I and Q varies only once per slot. This may reduce the impact to the cubic metric.

At 604, the slots which are not reserved for Acks as well as slots in which a Nack is sent may be transmitted without a change to the transmit power. In order to avoid a discontinuity in transmission power a Nack can be sent using a dummy symbol rather than using zero transmission power. An Ack can be sent either using the same symbol, but sent at a higher power level. As another option, an Ack can be sent using a different symbol than the Nack. For example, an Ack could be sent using +1 while a Nack is sent using −1. This may make it easier for a receiver to decide between an Ack and a Nack when decoding the transmission.

At 606, the Ack is transmitted by modulating a codeword pattern onto the symbols that would normally be transmitted in the slot. In an aspect, the modulation may be performed by a modulation module, e.g., 814 as illustrated in connection with FIG. 8.

The pattern of symbols may be modulated to provide orthogonal binary codewords at 620. Thus, the modulation may provide orthogonal binary codewords that modulate, e.g., a pilot symbol pattern for an Ack as opposed to a Nack. The pattern may comprise an equal number of +1 and −1 symbols on a subset of DPCCH symbols that would normally be transmitted in the slot. For example, when symbols p1, p2, p3, p4, p5, p6 would normally be sent in a particular slot, the pattern may be modulated to form orthogonal codewords p1, p2, p3, −p4, −p5, and −p6 for an Ack, while a Nack would be indicated by sending the symbols without modulation, e.g., p1, p2, p3, p4, p5, p6. A receiver can then distinguish an Ack from a Nack by comparing the energies of the correlations between the vectors of received pilots r1, r2, r3, r4, r5, r6 and the two orthogonal vectors [1 1 1 1 1 1] and [1 1 1 −1 −1 −1], as described in connection with FIG. 7.

Thus, as noted, the Nack may be transmitted without a change to the pattern of symbols.

In addition to the modulation of the codeword pattern onto the symbols, the Ack may be transmitted using a boosted transmit power in the slots in which the Ack is signaled, similar to the boost applied at 604.

The symbols that are modulated by the codeword pattern may comprise at least one of pilot symbols, TPC symbols, and TFCI symbols.

The symbols that are modulated by the codeword pattern may initially comprise any of pilot symbols and TPC symbols, and the symbols may be extended to include TFCI symbols once the TFCI symbols have been decoded by their receiver. For example, the symbols that are modulated may be extended to include TFCI symbols upon a determination that the TFCI has been decoded by its receiver. This determination may be made by receiving an Ack on the downlink, for example.

The Ack can be distributed over multiple pilot symbols. This reduces the extra power requirement to transmit the Ack. Transmitting the codeword pattern over pilot symbols avoids having to reserve slots in which the TPC field is replaced by an Ack field, which enables the TPC field to be sent every slot, e.g., preserving the 1500 Hz downlink power control rate.

When the pattern of symbols comprises TPC symbols, the symbols representing 10 and 01 may be used to indicate an Ack. In this case, the modulation by the orthogonal vectors can be applied only to the TPC field, instead of on the pilots or TFCI. This enables the pilots to be used as a phase reference to demodulate the resulting TPC/Ack-Nack filed. For example, if the TPC field has two bits, the current specification requires transmission of 00 or 11 to indicate an up or down command. The unused values 10 and 01 can be used to multiplex the Ack information along with the TPC. For example, the value 10 could represent Ack and TPC up command, while 01 could represent Ack and TPC down command. The values 00 and 11 retain their meanings as per the current specification and signify Nack in addition to those meanings.

The Ack can be transmitted on DPDCH at 608. The power ratio between the DPDCH and DPCCH can be increased in the slot where the Ack is sent, relative to the value that would have otherwise been used at 624. Even under normal operation, e.g., when no Ack is sent, the power ratio can vary depending on the packet type sent. Thus, in order to signal Ack, either a fixed power ratio between DPDCH and DPCCH can be used to signify an Ack or a fixed increase in this power ratio between DPDCH and DPCCH, relative to what would normally have been sent for the particular packet type being sent, can be sent to signify an Ack. The power ratio between the DPDCH and the DPCCH that is used to signify the Ack can be a pre-determined ratio. Regardless of whether the fixed power or the increase in power is used, the value of the power ratio quantity can differ depending on whether the DPDCH has been determined to have been decoded. In an aspect, the transmission via DPDCH is performed by a DPDCH module, e.g., 816 in FIG. 8.

By using DPDCH to send Ack rather than sending an Ack on a separate spreading code avoids an impact on the cubic metric that would be caused by the spreading code. It also avoids requiring a receiver to monitor receptions on this additional spreading code.

The Ack may be transmitted by reusing the DPDCH after determining that the DPDCH has been decoded at 626. If the DPDCH has already been decoded and acknowledged, the transmitter would have turned off DPDCH transmissions. Hence the DPDCH can then be re-used to send an Ack. The Ack transmission can be delayed until a determination is made that the DPDCH has been decoded. This increases the reliability of the Ack.

The Ack can be transmitted using a pre-determined set of symbols. In another aspect, the Ack can be transmitted using the symbols that would have been transmitted if the DPDCH had not yet been decoded. As another aspect, the Ack can be transmitted using a function of these symbols that would have been transmitted if the DPDCH had not yet been decoded, e.g., negatives of the symbols that would have been transmitted.

If, e.g., a downlink DPDCH has already been decoded, the Ack power can be spread out over several DPDCH symbols rather than concentrating a very high sending power in a single Ack symbol, thereby reducing the harmful RF effects. This also enables sending an Ack in any slot, reducing Ack delay compared to situations in which the Ack can only be sent in a certain reserved subset of slots.

The transmission can made be at a pre-determined power offset, T2P, with respect to DPCCH, which need not be the same as the usual DPDCH T2P used for other slots where Ack is not sent. Even if the DPDCH transmission has not yet been decoded, an Ack may be signalled in a slot by increasing the DPDCH T2P for that slot. This increase will be harder to detect when compared to the situation when the DPDCH has already decoded, where the detector was faced with merely detecting presence or absence of the DPDCH. This could be compensated for by using a sufficiently larger T2P increase. The value of the T2P increase used could also be a function of other parameters such as the spreading factor, which may affect the performance of the receiver subsystem that detects this T2P increase. The detection can possibly be further aided by repeating the Ack over multiple slots as at 612, or until a determination that it has been received. The determination regarding whether an Ack has been received can be made by monitoring receiver power of the downlink data packet to determine that its transmission has ceased.

Reusing DPDCH for an Ack can be performed for either Ack transmissions on the uplink to acknowledge downlink packet transmissions or for Ack transmission on the downlink to acknowledge uplink packets.

The aspects described in connection with FIG. 6 may applied to transmit an Ack on either an UL or on a DL, e.g., an UL or a DL DPDCH/DPCCH.

FIG. 7 is a flow chart of a method 700 of wireless communication. The method may be performed by a wireless device that transmits packets of wireless communication, such as a UE or Node B. In an aspect, the device may be apparatus 902 as described in connection with FIG. 9. The device may transmit the packets to a receiving device, e.g., 950 in FIG. 9 or 802 in FIG. 8.

At 602, the device transmits wireless communication, e.g., to the receiving device. This may comprise beginning a transmission of a packet. In an aspect, this transmission may be performed by a transmission module, e.g. 908 illustrated in FIG. 9.

At 704, the device receives an Ack regarding the transmission. In an aspect, the reception is performed by a reception module, e.g., 904 in FIG. 9. The Ack can be received as a transmission using at least one of a pre-configured boost applied to the transmit power of at least a portion of a slot in which the Ack is transmitted, a modulation of a codeword pattern onto the symbols that would normally be transmitted in the slot, and a transmission on DPDCH.

The Ack can be received on certain slots of an R99 uplink channel for traffic packets sent on an R99 downlink channel. The R99 uplink channel can comprise a DPCCH channel. The Ack can be received on either the UL or the DL.

The Ack may indicate early decoding of a packet comprised in the transmission prior to receiving the entire packet. Thus, at 706, the device can cease transmission of the packet, prior to transmitting the entire packet, in response to receiving the Ack that informs the device that the receiving device has already decoded the packet. For example, the transmission module 908 can cease transmission based on a determination by Ack/Nack detecting module 910 that an Ack has been received.

When the Ack is received as a transmission having a pre-configured boost applied to the transmit power of at least a portion of a slot in which the Ack is transmitted, the boost can be applied to the transmit power of the Ack symbol in the slot. In an aspect, the device can use pilot symbols transmitted in the same slot as the Ack on a DPCCH as a phase reference for decoding the Ack at 708. In an aspect, the use of pilot symbols as a phase reference can be performed by Ack/Nack detecting module, e.g., 910 in order to detect the Ack. In another aspect, the device can modify receiver algorithms to account for the boost applied to the transmit power of the Ack when an Ack is determined to have been transmitted in a slot at 710. The modification can be performed by a receiver modification module, e.g., 912 in FIG. 9. In another aspect, the device can compute transmit powers of other channels at 712 based on their T2P ratios and the transmit power without a boost. In an aspect, computation of the transmit powers of other channels can be performed by transmit power module, e.g., 914 in FIG. 9.

In another aspect, the Ack can be received as a transmission having a pre-configured boost applied to the transmit power of at least a portion of a slot in which the Ack is transmitted, the boost being applied to the transmit power of the entire slot in which the Ack is transmitted.

In another aspect, the Ack can be received as a transmission having a pre-configured boost applied to the transmit power of at least a portion of a slot in which the Ack is transmitted. A pre-defined boost P can be applied to the transmit power being applied to all non-TPC symbols in the slot, and a boost of P/2 can be applied to the TPC symbols and the Ack. The Ack can be I-Q multiplexed with the TPC symbol.

Slots not reserved for Acks and slots in which a Nack is sent can be received as transmissions without a change to the transmit power.

When the Ack is received as a transmission having a modulation of a codeword pattern onto the symbols that would normally be received in the slot, the codeword pattern can be modulated to provide orthogonal binary codewords for an Ack as opposed to a Nack. For example, the codeword pattern can comprise an equal number of +1 and −1 symbols on a subset of DPCCH symbols that would normally be received in the slot. A Nack can be received without a change to the symbols. At 714, the device may decode the Ack by comparing the energies of the received Ack to two orthogonal vectors. In an aspect, the decoding may be performed by the Ack/Nack detecting module, e.g., 910 in FIG. 9, in order to detect the Ack.

The Ack having a modulation of a codeword pattern onto the symbols can also be received having a boosted transmit power in the slots in which the Ack is signaled.

The symbols modulated by the codeword pattern can comprise at least one of pilot symbols, TPC symbols, and TFCI symbols. Symbols modulated by the codeword pattern comprising pilot symbols may be distributed over multiple pilot symbols.

Symbols modulated by the codeword pattern that comprise TPC symbols can comprise one of the symbols representing 10 and 01, as described in connection with FIG. 6. At 716, the device can use a pilot as a phase reference to demodulate the TPC symbols in order to decode the Ack. In an aspect, the use of the pilot may be performed by the Ack/Nack detecting module, e.g., 910 in FIG. 9, in order to detect the Ack.

When the Ack is received as a transmission on DPDCH, one of a fixed power ratio between the DPDCH and DPCCH and an increase in the power ratio between DPDCH and DPCCH can be used to signify an Ack, e.g., in a slot where an Ack is received, relative to the value that would have otherwise been used. The power ratio between DPDCH and DPCCH used to signify the Ack can be pre-determined Whether the fixed power ratio or the increase in the power ratio is used, the value of the power ratio can differ depending on whether the DPDCH has been decoded.

The Ack can be received as a transmission reusing the DPDCH after the DPDCH has been decoded. In an aspect, the Ack can be received as a transmission using a pre-determined set of symbols. In another aspect, the Ack can be received as a transmission using the symbols that would have been transmitted if the DPDCH had not yet been decoded. In yet another aspect, the Ack can be received as a transmission using a function of the symbols that would have been transmitted if the DPDCH had not yet been decoded.

FIG. 8 is a conceptual data flow diagram 800 illustrating the data flow between different modules/means/components in an exemplary apparatus 802. The apparatus may be a device that receives wireless communication of packets, as described in connection with aspects of FIG. 6. The device may be, e.g., a UE or a Node B. The apparatus 802 includes a reception module 804 that receives a transmission from a transmitting device 850. The transmitting device 850 is a device that transmits packets of wireless communication, e.g., a UE or a Node B. The apparatus 802 can optionally include a decoding module 806 that attempts to early decode the packet prior to reception of the entire packet, and a transmission module 808 that transmits an Ack regarding the receiving transmission, e.g., an Ack of early decoding once the early decoding has been performed. The Ack is transmitted to transmitting device 850 by transmission module 808. The Ack may be transmitted using any of applying a pre-configured boost to the transmit power of at least a portion of a slot in which the Ack is transmitted, modulating a codeword pattern onto the symbols that would normally be transmitted in the slot, and transmitting the Ack on DPDCH, as described in connection with FIG. 6.

The apparatus 802 may further include an Ack/Nack determination module 810 that determines whether to repeat an Ack. The determination may be based on whether the previous Ack was received, e.g., this may include a further determination of whether transmission of the packet by transmitting device 850 has ceased.

The apparatus 802 may further include a boost module 812 that applies a pre-configured boost to the transmit power of at least a portion of a slot in which the Ack is transmitted, as described in connection with FIG. 6.

The apparatus may further include a modulation module 814 that modulates a codeword pattern onto the symbols that would normally be transmitted in the slot, in order to indicate the Ack, as described in connection with FIG. 6.

The apparatus may further include a DPDCH module 816 that transmits the Ack on DPDCH, as described in connection with FIG. 6, e.g., by reusing the DPDCH once it has been decoded.

The apparatus may include additional modules that perform each of the steps of the algorithm in the aforementioned flow charts of FIG. 6. As such, each step in the aforementioned flow charts of FIG. 6 may be performed by a module and the apparatus may include one or more of those modules. The modules may be one or more hardware components specifically configured to carry out the stated processes/algorithm, implemented by a processor configured to perform the stated processes/algorithm, stored within a computer-readable medium for implementation by a processor, or some combination thereof.

FIG. 9 is a conceptual data flow diagram 900 illustrating the data flow between different modules/means/components in an exemplary apparatus 902. The apparatus 902 may be a device that transmits wireless communication, as described in connection with aspects of FIG. 7. The apparatus 902 may be, e.g., a UE or a Node B. The apparatus 902 includes a transmission module 908 that transmits wireless communication to a receiving device 950. The receiving device is a device that receives packets of wireless communication, e.g., a UE or a Node B. The receiving device 950 may be similar to apparatus 802 described in connection with FIG. 8.

The apparatus 902 also includes a reception module 904 that receives an Ack regarding the transmission, e.g., an Ack of early decoding, from receiving device 950. This Ack can be received prior to transmission of the entire packet by transmission module 908. The Ack can be received as one of a transmission using any of a pre-configured boost applied to the transmit power of at least a portion of a slot in which the Ack is transmitted, a modulation of a codeword pattern onto symbols that would normally be transmitted in the slot, and a transmission on DPDCH, as described in connection with FIG. 7.

The apparatus may further comprise an Ack/Nack detecting module 810 that determines an Ack. Once an Ack of early decoding is received, as determined by an Ack/Nack detecting module 910, the transmission module 908 can cease transmission of the packet. Depending on the manner in which the Ack is transmitted, the Ack/Nack detecting 910 may determine an Ack, e.g., decode an Ack, using any of pilot symbols transmitted in the same slot as the Ack on a DPCCH as a phase reference for decoding the Ack, comparing the energies of the received Ack to two orthogonal vectors, and using a pilot as a phase reference to demodulate a modulated pattern of TPC symbols in order to decode the Ack.

The apparatus 902 may include a receiver modification module 912 that modifies receiver algorithms to account for the boost applied to the transmit power of the Ack when an Ack is determined to have been transmitted in a slot, e.g., by Ack/Nack detecting module 910. The apparatus may include a transmit power module 914 that computes transmit powers of other channels based on their T2P ratios and the transmit power without a boost. In an aspect, computation of the transmit powers of other channels can be performed by transmit power module 914.

The apparatus may include additional modules that perform each of the steps of the algorithm in the aforementioned flow charts of FIG. 7. As such, each step in the aforementioned flow charts of FIG. 7 may be performed by a module and the apparatus may include one or more of those modules. The modules may be one or more hardware components specifically configured to carry out the stated processes/algorithm, implemented by a processor configured to perform the stated processes/algorithm, stored within a computer-readable medium for implementation by a processor, or some combination thereof.

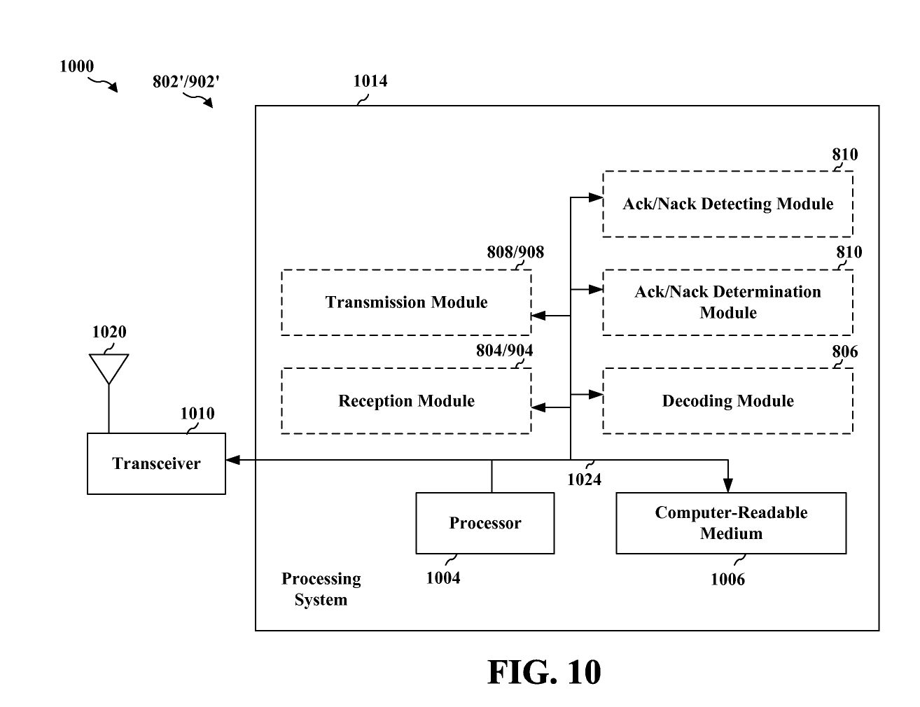

As illustrated in FIG. 10, a single apparatus may include both the modules for the reception functions of early decoding and the transmission functions related to early decoding, e.g., a single apparatus may include the modules to send Acks of early decoding and to receive such Acks.

FIG. 10 is a diagram 1000 illustrating an example of a hardware implementation for an apparatus 802′/902′ employing a processing system 1014. The processing system 1014 may be implemented with a bus architecture, represented generally by the bus 1024. The bus 1024 may include any number of interconnecting buses and bridges depending on the specific application of the processing system 1014 and the overall design constraints. The bus 1024 links together various circuits including one or more processors and/or hardware modules, represented by the processor 1004, any of the modules 804, 806, 808, 810, 812, 814, 816, 904, 908, 910, 912, and 914 and the computer-readable medium 1006. The bus 1024 may also link various other circuits such as timing sources, peripherals, voltage regulators, and power management circuits, which are well known in the art, and therefore, will not be described any further.

The processing system 1014 may be coupled to a transceiver 1010. The transceiver 1010 is coupled to one or more antennas 1020. The transceiver 1010 provides a means for communicating with various other apparatus over a transmission medium. The processing system 1014 includes a processor 1004 coupled to a computer-readable medium 1006. The processor 1004 is responsible for general processing, including the execution of software stored on the computer-readable medium 1006. The software, when executed by the processor 1004, causes the processing system 1014 to perform the various functions described supra for any particular apparatus. The computer-readable medium 1006 may also be used for storing data that is manipulated by the processor 1004 when executing software. The processing system further includes at least one of the modules 804, 806, 808, 810, 812, 814, 816, 904, 908, 910, 912, and 914. The modules may be software modules running in the processor 1004, resident/stored in the computer readable medium 1006, one or more hardware modules coupled to the processor 1004, or some combination thereof. When apparatus 802′ or 902′ is a Node B, the processing system 1014 may be a component of the Node B 410 and may include the memory 442 and/or at least one of the TX processor 420, the RX processor 438, and the controller/processor 440. When apparatus 802′ or 902′ is a UE, the processing system 1014 may be a component of the UE 450 and may include the memory 492 and/or at least one of the TX processor 480, the RX processor 470, and the controller/processor 490.

The various illustrative logics, logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Additionally, at least one processor may comprise one or more modules operable to perform one or more of the steps and/or actions described above.

Further, the steps and/or actions of a method or algorithm described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. An exemplary storage medium may be coupled to the processor, such that the processor can read information from, and write information to, the storage medium. In the alternative, the storage medium may be integral to the processor. Further, in some aspects, the processor and the storage medium may reside in an ASIC. Additionally, the ASIC may reside in a user terminal. In the alternative, the processor and the storage medium may reside as discrete components in a user terminal. Additionally, in some aspects, the steps and/or actions of a method or algorithm may reside as one or any combination or set of codes and/or instructions on a machine readable medium and/or computer readable medium, which may be incorporated into a computer program product.

In one or more aspects, the functions described may be implemented in hardware, software, firmware, or any combination thereof. If implemented in software, the functions may be stored or transmitted as one or more instructions or code on a computer-readable medium. Computer-readable media includes both computer storage media and communication media including any medium that facilitates transfer of a computer program from one place to another. A storage medium may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection may be termed a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs usually reproduce data optically with lasers. Combinations of the above should also be included within the scope of computer-readable media.

Several aspects of a telecommunications system have been presented with reference to a W-CDMA system. As those skilled in the art will readily appreciate, various aspects described throughout this disclosure may be extended to other telecommunication systems, network architectures and communication standards.

By way of example, various aspects may be extended to other UMTS systems such as TD-SCDMA, High Speed Downlink Packet Access (HSDPA), High Speed Uplink Packet Access (HSUPA), High Speed Packet Access Plus (HSPA+) and TD-CDMA. Various aspects may also be extended to systems employing Long Term Evolution (LTE) (in FDD, TDD, or both modes), LTE-Advanced (LTE-A) (in FDD, TDD, or both modes), CDMA2000, Evolution-Data Optimized (EV-DO), Ultra Mobile Broadband (UMB), IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

While the foregoing disclosure discusses illustrative aspects and/or embodiments, it should be noted that various changes and modifications could be made herein without departing from the scope of the described aspects and/or embodiments as defined by the appended claims. Furthermore, although elements of the described aspects and/or embodiments may be described or claimed in the singular, the plural is contemplated unless limitation to the singular is explicitly stated. Additionally, all or a portion of any aspect and/or embodiment may be utilized with all or a portion of any other aspect and/or embodiment, unless stated otherwise.

What is claimed is:

1. A method of wireless communication comprising:
receiving a transmission; and
transmitting an acknowledgement (Ack) regarding the transmission using at least one of:
applying a pre-configured boost to the transmit power of at least a portion of a slot in which the Ack is transmitted;
modulating a codeword pattern onto symbols that would normally be transmitted in the slot; and
transmitting the Ack on a dedicated physical data channel (DPDCH).

2. The method of claim 1, wherein the Ack is transmitted on certain slots of an R99 uplink channel for traffic packets sent on an R99 downlink channel, wherein the R99 uplink channel comprises a dedicated physical control channel (DPCCH).

3. The method of claim 1, further comprising:
early decoding a packet comprised in the transmission prior to receiving the entire packet, wherein the Ack indicates that the packet has been early decoded; and
determining whether to transmit an additional Ack, wherein the determination is based on whether transmission of the packet has ceased.

4. The method of claim 1, wherein the Ack is transmitted on an UL.

5. The method of claim 1, wherein the Ack is transmitted on a DL.

6. The method of claim 1, wherein the Ack is transmitted by applying a pre-configured boost to the transmit power of at least a portion of a slot in which the Ack is transmitted, the boost being applied to either the transmit power of the Ack symbol in the slot or to the entire slot in which the Ack is transmitted,
wherein slots not reserved for the Ack and slots in which a negative acknowledgement (Nack) is sent are transmitted without a change to the transmit power.

7. The method of claim 1, wherein the Ack is transmitted by applying a pre-configured boost to the transmit power of at least a portion of a slot in which the Ack is transmitted,
wherein a pre-defined boost P is applied to the transmit power being applied to all non-TPC symbols in the slot,
wherein a boost of P/2 is applied to the transmitter power control (TPC) symbols and the Ack, and
wherein the Ack is in-phase-quadrature-phase (I-Q) multiplexed with the TPC symbol.

8. The method of claim 1, wherein the Ack is transmitted by modulating a codeword pattern onto the symbols that would normally be transmitted in the slot, the codeword pattern being modulated to provide orthogonal binary codewords for an Ack as opposed to a negative acknowledgement (Nack), wherein Nack is transmitted without a change to the modulated symbols.

9. The method of claim 8, wherein the codeword pattern comprises an equal number of +1 and −1 symbols on a subset of dedicated physical control channel (DPCCH) symbols that would normally be transmitted in the slot.

10. The method of claim 8, wherein the symbols modulated by the codeword pattern comprise at least one of pilot symbols, transmitter power control (TPC) symbols, and transport format combination indicator (TFCI) symbols,
wherein when the symbols modulated by the codeword pattern comprise pilot symbols, the symbols are extended to include TFCI symbols upon a determination that the TFCI has been decoded by its receiver or the Ack is distributed over multiple pilot symbols, and
wherein when the symbols modulated by the codeword pattern comprise TPC symbols, the Ack comprises one of the symbols representing 10 and 01.

11. The method of claim 1, wherein the Ack is transmitted on dedicated physical data channel (DPDCH), wherein the power ratio between the DPDCH and dedicated physical control channel (DPCCH) is increased in the slot where the Ack is sent, relative to the value that would have otherwise been used.

12. The method of claim 11, wherein one of a fixed power ratio between DPDCH and DPCCH and an increase in the power ratio between DPDCH and DPCCH is used to signify the Ack, and wherein value of the fixed power ratio or the increase in the power ratio depends on whether the DPDCH has been determined to have been decoded.

13. The method of claim 1, wherein the Ack is transmitted reusing the dedicated physical data channel (DPDCH) after determining that the DPDCH has been decoded, wherein the Ack is transmitted using one of:
a pre-determined set of symbols;
the symbols that would have been transmitted if the DPDCH had not yet been decoded;
a function of the symbols that would have been transmitted if the DPDCH had not yet been decoded; and
a delay until a determination that the DPDCH has been decoded.

14. A computer program product, comprising:
a computer-readable medium storing processor-readable instructions configured to cause a computer to:
receive a transmission; and
transmit an acknowledgement (Ack) regarding the transmission using at least one of:
applying a pre-configured boost to the transmit power of at least a portion of a slot in which the Ack is transmitted;
modulating a codeword pattern onto symbols that would normally be transmitted in the slot; and
transmitting the Ack on a dedicated physical data channel (DPDCH).

15. An apparatus, comprising:
a receiver configured to receive a transmission; and
a transmitter configured to transmit an acknowledgement (Ack) regarding the transmission using at least one of:
applying a pre-configured boost to the transmit power of at least a portion of a slot in which the Ack is transmitted;
modulating a codeword pattern onto symbols that would normally be transmitted in the slot; and
transmitting the Ack on a dedicated physical data channel (DPDCH).

16. The apparatus of claim 15, further comprising at least one of:
a decoder configured to early decode a packet comprised in the transmission prior to receiving the entire packet, wherein the Ack indicates that the packet has been early decoded; and
an Ack determination module configured to determine whether to transmit an additional Ack.

17. The apparatus of claim 15, wherein the Ack is transmitted by applying a preconfigured power boost to at least one of:
a portion of a slot in which the Ack is transmitted, the boost being applied to the transmit power of the Ack symbol in the slot;
the transmit power of the entire slot in which the Ack is transmitted; and
at least a portion of a slot in which the Ack is transmitted, wherein a pre-defined boost P is applied to the transmit power being applied to all non-TPC symbols in the slot, wherein a boost of P/2 is applied to the transmitter power control (TPC) symbols and the Ack, and wherein the Ack is in-phase-quadrature-phase (I-Q) multiplexed with the TPC symbol.

18. The apparatus of claim 15, wherein the Ack is transmitted by modulating a codeword pattern onto the symbols that would normally be transmitted in the slot, the codeword pattern being modulated to provide orthogonal binary codewords for an Ack as opposed to a negative acknowledgement (Nack).

19. An apparatus, comprising:
means for receiving a transmission; and
means for transmitting an acknowledgement (Ack) regarding the transmission using at least one of:
applying a pre-configured boost to the transmit power of at least a portion of a slot in which the Ack is transmitted;
modulating a codeword pattern onto symbols that would normally be transmitted in the slot; and
transmitting the Ack on a dedicated physical data channel (DPDCH).

20. The apparatus of claim 19, further comprising:
means for early decoding a packet comprised in the transmission prior to receiving the entire packet, wherein the Ack indicates that the packet has been early decoded.

21. The apparatus of claim 20, further comprising:
means for determining whether to transmit an additional Ack, wherein the determination is based on whether transmission of the packet has ceased.

22. A method of wireless communication comprising:
transmitting wireless communication; and
receiving an acknowledgement (Ack) regarding the transmission, wherein the Ack is received as a transmission using at least one of:
a pre-configured boost applied to the transmit power of at least a portion of a slot in which the Ack is transmitted;
a modulation of a codeword pattern onto symbols that would normally be transmitted in the slot; and
a transmission on a dedicated physical data channel (DPDCH).

23. The method of claim 22, wherein the Ack is received on certain slots of an R99 uplink channel for traffic packets sent on an R99 downlink channel, and wherein the R99 uplink channel comprises a dedicated physical control channel (DPCCH).

24. The method of claim 22, wherein the Ack indicates early decoding of a packet comprised in the transmission prior to receiving the entire packet, the method further comprising:
ceasing transmission of the packet upon receipt of the Ack.

25. The method of claim 22, wherein the Ack is received as a transmission having a pre-configured boost applied to the transmit power of at least a portion of a slot in which the Ack is transmitted, the boost being applied to the transmit power of the Ack symbol in the slot, wherein slots not reserved for the Ack and slots in which a negative acknowledgement (Nack) is sent are received as transmissions without a change to the transmit power, the method further comprising at least one of:
using a pilot symbol transmitted in the same slot as the Ack on a dedicated physical control channel (DPCCH) as a phase reference for decoding the Ack;
modifying receiver algorithms to account for the boost applied to the transmit power of the Ack when an Ack is determined to have been transmitted in a slot; and
computing transmit powers of other channels based on their T2P ratios and the transmit power without a boost.

26. The method of claim 22, wherein the Ack is received as a transmission having a pre-configured boost applied to the transmit power of at least a portion of a slot in which the Ack is transmitted,
wherein a pre-defined boost P is applied to the transmit power being applied to all non-TPC symbols in the slot,
wherein a boost of P/2 is applied to the transmitter power control (TPC) symbols and the Ack, and
wherein the Ack is in-phase-quadrature-phase (I-Q) multiplexed with the TPC symbol.

27. The method of claim 22, wherein the Ack is received as a transmission having a modulation of a codeword pattern onto the symbols that would normally be received in the slot, wherein the codeword pattern is modulated to provide orthogonal binary codewords for an Ack as opposed to a negative acknowledgement (Nack), the method further comprising:
decoding the Ack by comparing the energies of the received Ack to two orthogonal vectors,
wherein the symbols modulated by the codeword pattern comprise at least one of pilot symbols, transmitter power control (TPC) symbols, and transport format combination indicator (TFCI) symbols.

28. The method of claim 27, wherein the symbols modulated by the codeword pattern comprise TPC symbols, and wherein the Ack comprises one of the symbols representing 10 and 01, the method further comprising:
using a pilot as a phase reference to demodulate the TPC symbols in order to decode the Ack.

29. The method of claim 22, wherein the Ack is received as a transmission on a dedicated physical data channel (DPDCH), wherein the power ratio between the DPDCH and dedicated physical control channel (DPCCH) is increased in the slot where the Ack is received, relative to the value that would have otherwise been used,
wherein one of a fixed power ratio between DPDCH and DPCCH and an increase in the power ratio between DPDCH and DPCCH is used to signify the Ack, the value of the fixed power ratio and the increase in the power ratio depending on whether the DPDCH has been decoded.

30. The method of claim 22, wherein the Ack is received as a transmission reusing the dedicated physical data channel (DPDCH) after the DPDCH has been decoded,
wherein the Ack is received as one of:
a transmission using a pre-determined set of symbols;
a transmission using the symbols that would have been transmitted if the DPDCH had not yet been decoded; and
a transmission using a function of the symbols that would have been transmitted if the DPDCH had not yet been decoded.

31. A computer program product, comprising:
a computer-readable medium storing processor-readable instructions configured to cause a computer to:
transmit wireless communication; and
receive an acknowledgement (Ack) regarding the transmission, wherein the Ack is received as a transmission using at least one of:
a pre-configured boost applied to the transmit power of at least a portion of a slot in which the Ack is transmitted;
a modulation of a codeword pattern onto symbols that would normally be transmitted in the slot; and
a transmission on a dedicated physical data channel (DPDCH).

32. An apparatus, comprising:
a transmitter configured to transmit wireless communication; and
a receiver configured to receive an acknowledgement (Ack) regarding the transmission, wherein the Ack is received as a transmission using at least one of:
a pre-configured boost applied to the transmit power of at least a portion of a slot in which the Ack is transmitted;
a modulation of a codeword pattern onto symbols that would normally be transmitted in the slot; and
a transmission on a dedicated physical data channel (DPDCH).

33. The apparatus of claim 32, wherein the transmitter is further configured to cease transmission of the packet when the Ack indicates early decoding of a packet comprised in the transmission prior to receiving the entire packet.

34. The apparatus of claim 32, wherein the Ack is received as a transmission having a pre-configured boost applied to the transmit power of at least a portion of a slot in which the Ack is transmitted, the boost being applied to the transmit power of the Ack symbol in the slot, the apparatus further comprising at least one of:
an Ack detecting module configured to use a pilot symbol transmitted in the same slot as the Ack on a dedicated physical control channel (DPCCH) as a phase reference for decoding the Ack;
a receiver modification module configured to modify receiver algorithms to account for the boost applied to the transmit power of the Ack when an Ack is determined to have been transmitted in a slot; and
a transmit power module configured to compute transmit powers of other channels based on their T2P ratios and the transmit power without a boost.

35. The apparatus of claim 32, wherein the Ack is received as a transmission having a modulation of a codeword pattern onto the symbols that would normally be received in the slot, wherein the codeword pattern is modulated to provide orthogonal binary codewords for an Ack as opposed to a negative acknowledgement (Nack), the apparatus further comprising:
an Ack detecting module configured to decode the Ack by at least one of:
comparing the energies of the received Ack to two orthogonal vectors, and
using a pilot as a phase reference to demodulate the TPC symbols in order to decode the Ack.

36. An apparatus, comprising:
means for transmitting wireless communication; and
means for receiving an acknowledgement (Ack) regarding the transmission, wherein the Ack is received as a transmission using at least one of:
a pre-configured boost applied to the transmit power of at least a portion of a slot in which the Ack is transmitted;
a modulation of a codeword pattern onto symbols that would normally be transmitted in the slot; and
a transmission on a dedicated physical data channel (DPDCH).

37. The apparatus of claim 36, further comprising:
means for using a pilot symbol transmitted in the same slot as the Ack on a dedicated physical control channel (DPCCH) as a phase reference for decoding the Ack.

38. The apparatus of claim 36, further comprising:
means for modifying receiver algorithms to account for the boost applied to the transmit power of the Ack when an Ack is determined to have been transmitted in a slot.

39. The apparatus of claim 36, further comprising:
means for computing transmit powers of other channels based on their T2P ratios and the transmit power without a boost.

40. The apparatus of claim 36, wherein the Ack is received as a transmission having a modulation of a codeword pattern onto the symbols that would normally be received in the slot, wherein the codeword pattern is modulated to provide orthogonal binary codewords for an Ack as opposed to a negative acknowledgement (Nack), the apparatus further comprising at least one of:
means for decoding the Ack by comparing the energies of the received Ack to two orthogonal vectors; and
means for using a pilot as a phase reference to demodulate the TPC symbols in order to decode the Ack, wherein the symbols modulated by the codeword pattern comprise TPC symbols, and wherein the Ack comprised one of the symbols representing 10 and 01.
